(19) United States
(12) Patent Application Publication
(10) Pub. No.: US 2001/0037348 A1
(43) Pub. Date: Nov. 1, 2001

(54) Electronic information delivery system

(76) Inventors: Kazuo Nakada, Kawasaki (JP); Fujio Ohara, Kawasaki (JP); Shiro Ohtsubo, Kawasaki (JP)

Correspondence Address: STAAS & HALSEY LLP, 700 11TH STREET, NW, SUITE 500, WASHINGTON, DC, 20001, US

(21) Appl. No.: 09/816,368

(22) Filed: Mar. 26, 2001

(30) Foreign Application Priority Data
Apr. 28, 2000 (JP) 2000-129170

(51) Int. Cl. G06F 17/24

(52) U.S. Cl. 707/530

(57) ABSTRACT

An electronic information delivery system for delivering newspaper information published by a plurality of publishers to a plurality of users comprises a newspaper database for storing the published newspaper information, an individual contract database for storing selection information that is used for selecting newspaper information necessary for each user, an edition processing portion for searching and editing newspaper information necessary for each user using the selection information from the newspaper information stored in the newspaper database, an individual newspaper database for storing the edited newspaper information for each user, and a data delivery processing portion for transmitting newspaper information stored in the individual newspaper database to each user via a network.

### BACKGROUND OF THE INVENTION

1. Field of the Invention

The present invention relates to electronic information delivery systems and recording media. More specifically the present invention relates to an electronic information delivery system for delivering newspaper information published by a plurality of publishers to a plurality of users.

2. Description of the Prior Art

Conventionally, a newspaper is delivered to each user (subscriber) at regular time zones in the morning and in the evening. A newspaper includes a front page, a social page, a financial page and other pages, each of which is edited using a headline, a crosshead and a subhead. A user can read the newspaper briefly or in detail at his or her convenience.

A system for electronizing a newspaper so as to deliver it to a user via a network is proposed in Japanese unexamined patent publication No. 8-256174.

This conventional system converts typesetting processed newspaper information into electronic newspaper information of a format that is suitable for an electronic transmission and browsing, and delivers it to a user via a communications satellite, a broadcast satellite, a ground wave broadcast, or a CATV. At a user's side, received electronic newspaper information is displayed on a screen in a low magnification first. If there is an article the user desires to read, it is displayed in a high magnification. Input equipment is used to perform an operation such as paging, scrolling, zooming or cutting so that the user can read the electronic newspaper in the same manner as a real newspaper.

In the above-mentioned conventional electronic newspaper information system, it is noted that the typesetting processed newspaper information is an electric signal, and the signal is converted into electronic newspaper information before transmitting the information to each user via various transmission media.

According to this method, though the user can read the newspaper information in a similar manner to that the user read as a real newspaper, each user has to select necessary information or desired information from all of the received newspaper information.

Since screen area of a display device is restricted, its browsability is inferior to that of a spread normal newspaper even if the display method is improved in any way. Therefore, it is not easy to select necessary information on a screen from the newspaper information that is similar to a newspaper page.

In addition, though the user can obtain all newspaper information and select necessary information therefrom by taking enough time, unnecessary information is also received. Therefore, the data quantity to be transmitted and that to be memorized in a user's terminal become large unnecessarily.

### SUMMARY OF THE INVENTION

An object of the present invention is to provide an electronic information delivery system and a recording medium in which a user can receive only necessary information, and the received information can be read easily by the user, and data transmission quantity and data memory quantity can be reduced.

According to one aspect of the present invention, the system comprises an information database for storing electronic information to be acquired, a selection information storing portion for storing selection information for each user, the information being used for selecting necessary information from the electronic information, an editing portion for searching and editing information necessary for each user using the selection information from the information stored in the information database, a user-edited information storing portion for storing the edited information for each user, and a transmitting portion for transmitting the information stored in the user-edited information storing portion to each user via a network.

If required, means for assigning a keyword to the electronic information to be stored in the information database is provided, and the selection information includes a keyword selected by the user. The editing portion searches and edits necessary information from the information stored in the information database in accordance with the keyword included in the selection information.

In the case where the electronic information delivery system is applied to an electronic newspaper, newspaper information is used as the electronic information. In this case, the editing portion is structured to edit the newspaper information for each page information. If the search is performed in accordance with a keyword, the searched newspaper information is edited as clipping information that is different from each of the page information. In addition, a bulletin database is provided for storing bulletin information that is published by a publisher. Newspaper information is transmitted to a user twice at a predetermined time zone in the morning and in the evening of the current day, and newly published bulletin information is transmitted to a user without delay.

The user terminal includes a memory device for storing newspaper information received from the newspaper information host system and a display device for displaying the newspaper information stored in the memory device.

The display device of the user terminal displays the newspaper information for each page. When new bulletin information is received, the display device displays a message indicating that new bulletin information is received.

According to another aspect of the present invention, the electronic information delivery system is realized by using a personal computer, a workstation, a general-purpose computer, mobile equipment or other various computers or devices, for example. A computer program for realizing the electronic information delivery system is stored in a recording medium such as a semiconductor memory, a hard disk, a CD-ROM, a floppy disk or a magneto-optical disk. The program recorded in the recording medium is timely loaded on a main memory and is executed by a processor. In this case, a drive device such as a CD-ROM drive, a floppy disk drive or a magneto-optical disk drive is used as necessity. If the recording medium is provided in a server that is connected with a communication line such as a network, the program is read or downloaded from the server via the communication line. The program can be supplied to work on various operating systems and platforms or under various system environments or network environments.

### BRIEF DESCRIPTION OF THE DRAWINGS

FIG. 1 is a block diagram showing a structure of an electronic newspaper system according to one aspect of the present invention.

FIG. 2 is a diagram showing a publisher database.

FIG. 3 is a diagram showing a newspaper database.

FIG. 4 is a diagram showing a bulletin database.

FIGS. 5-7 show a part of contents of data stored in an individual contract database.

FIG. 8 is a diagram showing an individual newspaper database.

FIG. 9 is a diagram showing an example of a newspaper picture displayed on a screen of a display device.

FIG. 10 is a diagram showing an example of a bulletin window that is displayed when bulletin information is transmitted to an user's terminal.

FIG. 11 is a diagram showing an example of a newspaper subscription order picture on the screen of the display device.

FIG. 12 is a diagram showing a form of a recording medium storing the program for realizing the electronic newspaper system.

### DESCRIPTION OF THE PREFERRED EMBODIMENTS

Hereinafter, an example of the present invention in which an electronic information delivery system is applied to an electronic newspaper system will be explained.

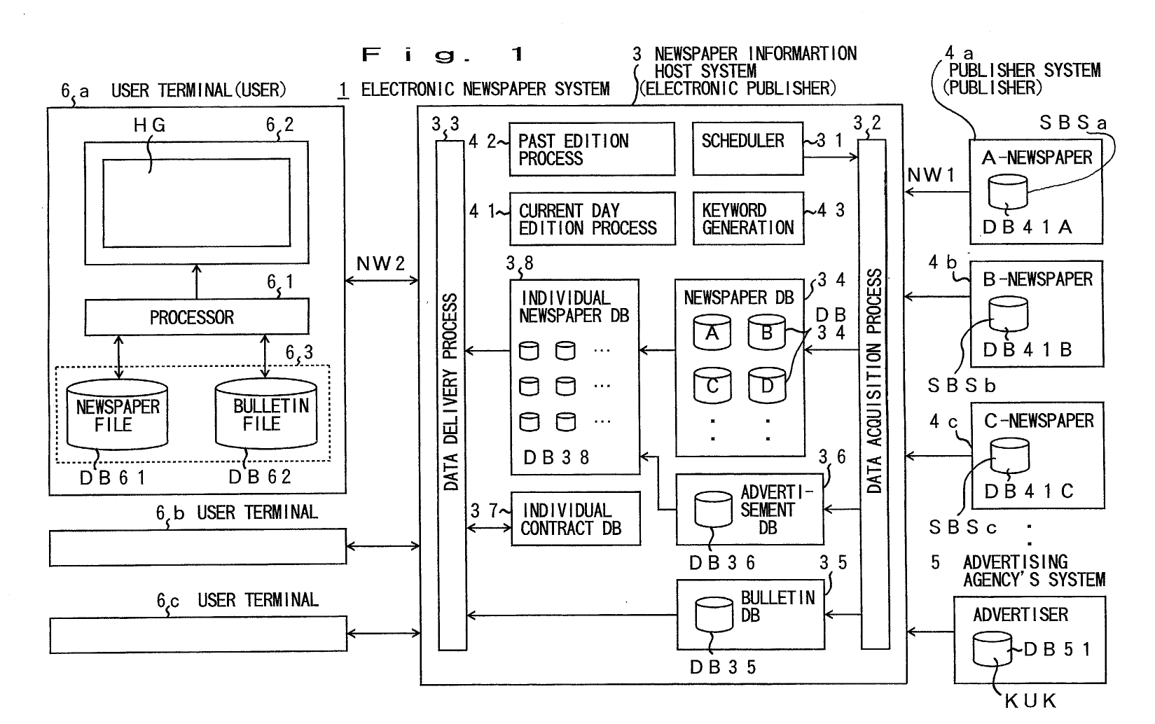

FIG. 1 is a block diagram showing a structure of an electronic newspaper system 1.

As shown in FIG. 1, the electronic newspaper system 1 comprises a newspaper information host system 3, publisher systems 4a, 4b, 4c . . . , an advertising agency's system 5, user terminals 6a, 6b, 6c . . . , and networks NW1 and NW2 for connecting them.

The publisher systems 4a, 4b, 4c, . . . and the user terminals 6a, 6b, 6c, . . . may be referred to as a “publisher system 4” or a “user terminal 6” as an indication of a whole or a part of them. The same way is also applicable to other elements. Furthermore, a plurality of advertising agency's systems 5 can be provided. The newspaper information host system 3 can be also provided to plural places.

The newspaper information host system 3 is installed in a building of an electronic publisher, for example. The newspaper information host system 3 comprises a scheduler 31, a data acquisition processing portion 32, a data delivery processing portion 33, a newspaper data memory portion 34, a bulletin data memory portion 35, an advertisement data memory portion 36, an individual contract data memory portion 37, an individual newspaper data memory portion 38, a current day edition processing portion 41, a past edition processing portion 42, and a keyword generating portion 43.

The newspaper data memory portion 34 includes a newspaper database DB34. The bulletin data memory portion 35 includes a bulletin database DB35. The advertisement data memory portion 36 includes an advertisement database DB36. The individual contract data memory portion 37 includes an individual contract database DB37. The individual newspaper data memory portion 38 includes an individual newspaper database DB38.

The data acquisition processing portion 32 communicates with the publisher system 4 and the advertising agency's system 5, so as to acquire necessary newspaper information SBS, bulletin information SHS, and advertisement data KUK. On this occasion, in accordance with a timing instructed by the scheduler 31, the data acquisition processing portion 32 transmits a data request to each publisher system 4 sequentially and receives the newspaper information SBS from each publisher system 4. However, without the timing instructed by the scheduler 31, the publisher system 4 can perform the transmission when publisher system 4 has prepared for the transmission of the newspaper information SBS.

The bulletin information SHS is transmitted from the newspaper information SBS when the bulletin information SHS is generated in the publisher system 4. However, for example, the newspaper information host system 3 may inquire of the publisher system 4 in a predetermined period, so as to transmit new bulletin information SHS, if the publisher system 4 has.

The data delivery processing portion 33 communicates between the newspaper information host system 3 and the user terminal 6 so as to transmit individual newspaper information KSB to each user terminal 6.

In this case, in accordance with a timing given by the scheduler 31, for example, the data delivery processing portion 33 transmits a start signal to the user terminal 6. The user terminal 6 starts the application for the reception, so as to prepare for the reception. After the user terminal 6 finished the preparation for the reception, the newspaper information host system 3 issues a transmission notice to the user terminal 6. When the user terminal 6 sends back a reception available signal, the newspaper information host system 3 transmits the individual newspaper information KSB. If a user terminal 6 did not be transmit the individual newspaper information KSB, the user terminal 6 may request the newspaper information host system 3 to download afterward. In accordance with the request, the newspaper information host system 3 may transmit the individual newspaper information KSB.

It is possible that each user terminal 6 always requests the newspaper information host system 3 to download, and then the individual newspaper information KSB is transmitted. If the user is out and uses mobile equipment for obtaining individual newspaper information KSB, the download request can be transmitted from the mobile equipment and a password or the like can be inputted thereby.

When the mobile equipment is used for receiving the individual newspaper information KSB, the information may be divided into plural sets having a respective size that can be displayed in the mobile equipment prior to downloading. Otherwise, only headline information is downloaded first and article information corresponding to the headline selected by the user may be downloaded each time.

Furthermore, the data delivery processing portion 33 can receive individual contract data D371-D373 that are transmitted from the user terminal 6 to the newspaper information host system 3 and other data or instructions, and can memorize or convert them for a necessary process.

Each publisher system 4 has a publisher database DB41A, DB41B, DB41C, . . . , in which newspaper information SBSa, SBSb, SBSc that is edited by A-publisher, B-publisher, C-publisher, . . . is stored.

The advertising agency's system 5 has an advertising agency's database DB51 memorizing much advertisement data KUK of companies or individuals that provide advertising.

The user terminal 6 includes a processor 61, a display device 62, and a memory device 63. The memory device 63 stores a newspaper file DB61, a bulletin file DB62, and the like.

The user terminal 6 can be a personal computer, a dedicated terminal device or a dual-purpose terminal, for example. Furthermore, various types of mobile equipment such as a cellular phone can be used as the user terminal 6.

The network NW1 can be a private line network or a public line network, for example. The network NW2 can be a public line network, a private line network, a CATV network, or the Internet. In any case, a wired line of a copper wire or an optical fiber, or a wireless line of a radio wave or an infrared radiation can be also used for the entire or a part of the network.

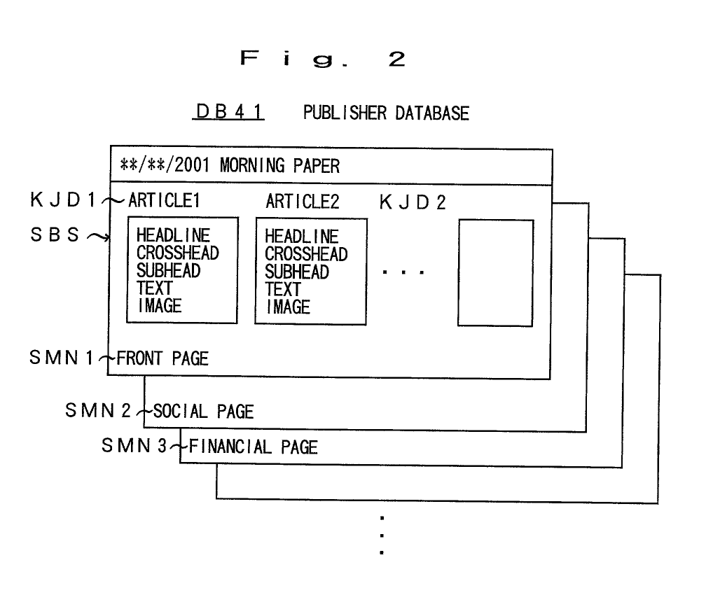

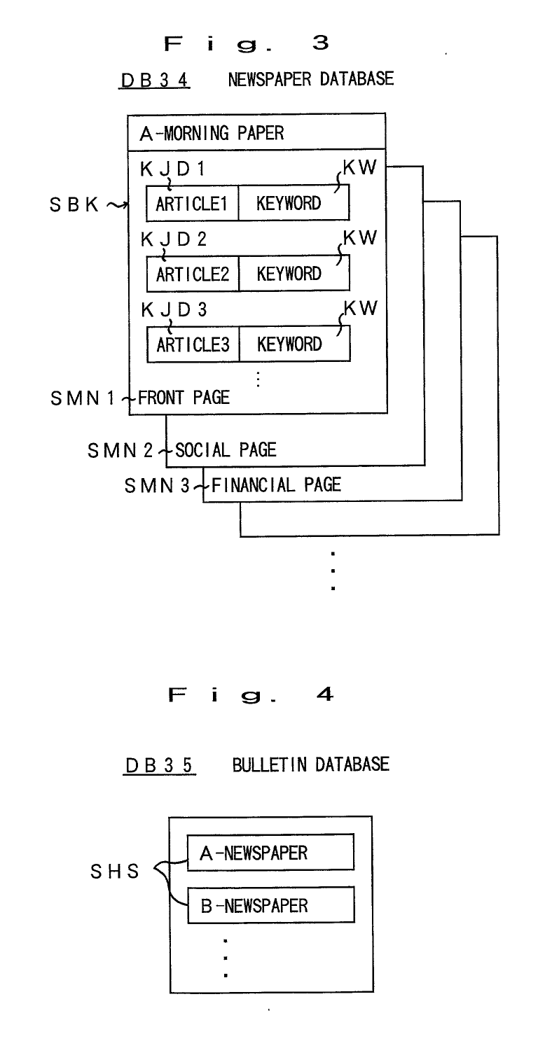

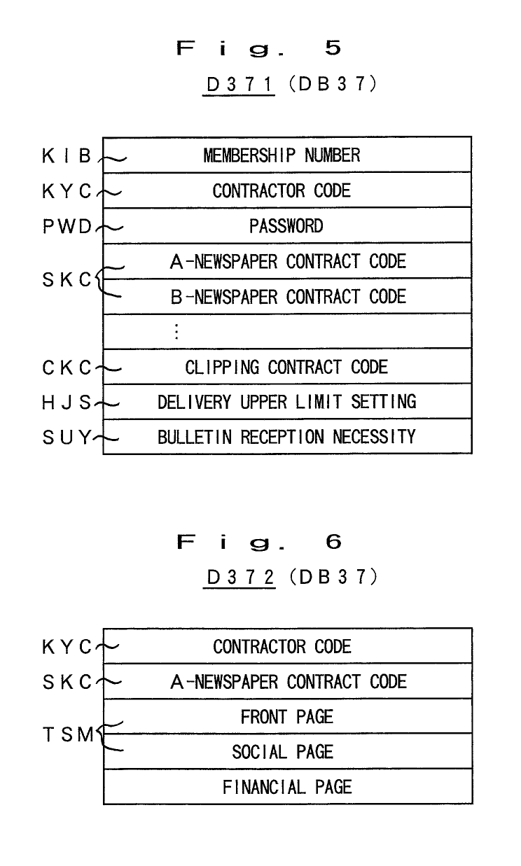

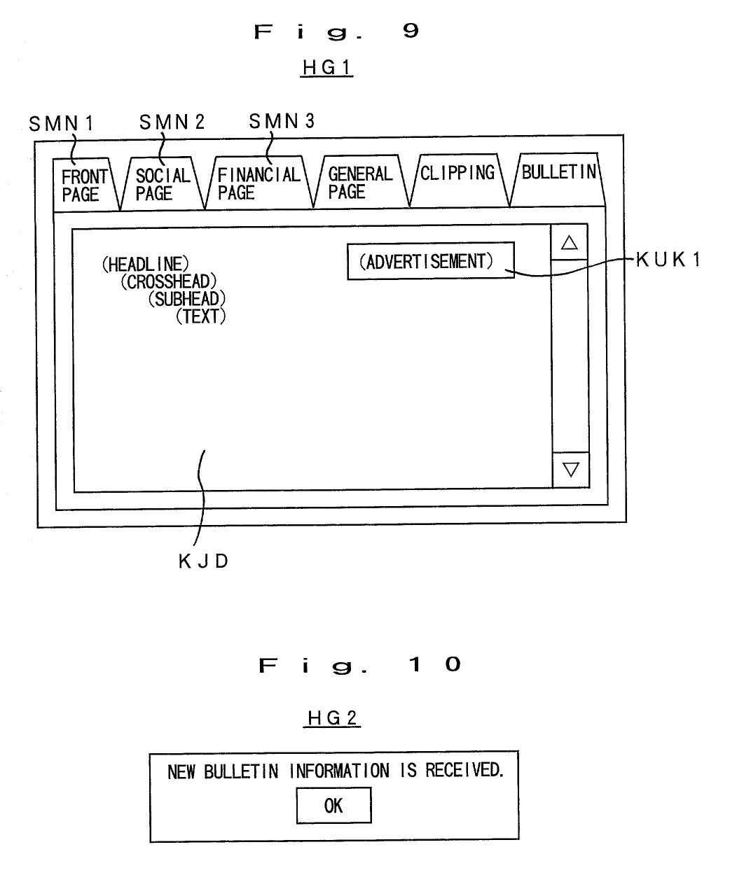

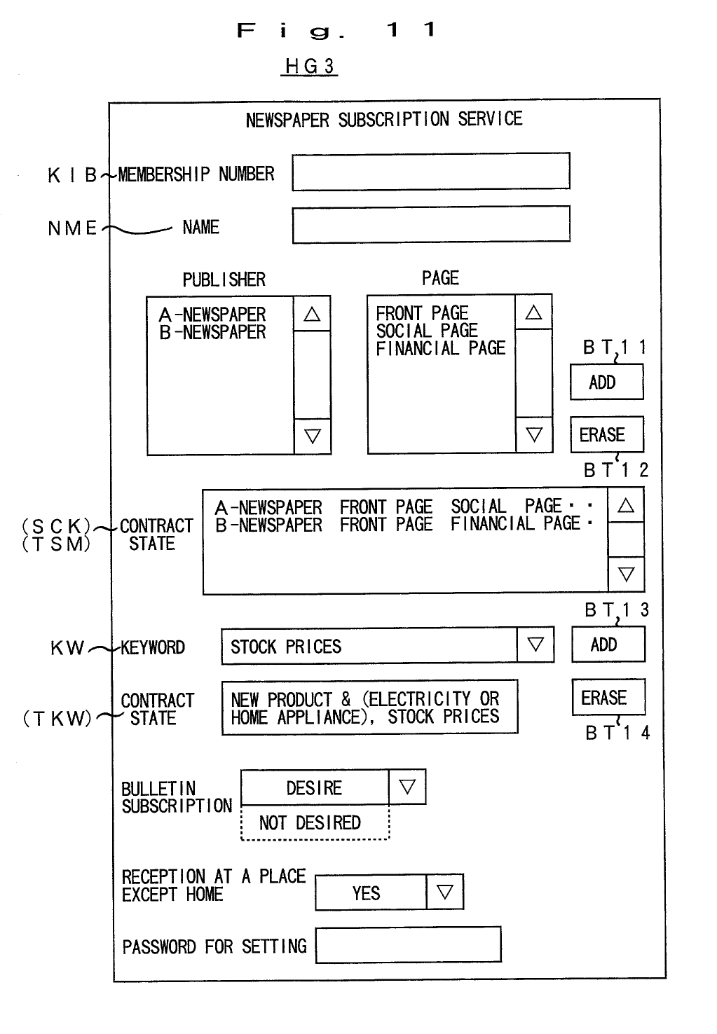

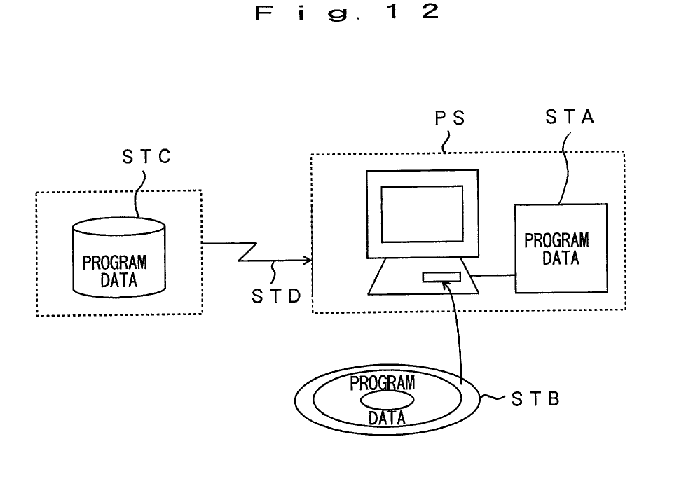

FIG. 2 is a diagram showing the publisher database DB41. FIG. 3 is a diagram showing the newspaper database DB34. FIG. 4 is a diagram showing the bulletin database DB35. FIGS. 5-7 show a part of contents of data D371-D373 stored in the individual contract database DB37, respectively. FIG. 8 is a diagram showing the individual newspaper database DB38. FIG. 9 is a diagram showing an example of the newspaper picture HG1 displayed on the screen of the display device 62. FIG. 10 is a diagram showing an example of a bulletin window HG2 that is displayed when the bulletin information is transmitted to the user terminal 6. FIG. 11 is a diagram showing an example of a newspaper subscription order picture HG3 that is displayed on the screen of the display device 62.

As shown in FIG. 2, the newspaper information SBS stored in the publisher database DB41 is organized for each page SMN such as a front page SMN1, a social page SMN2, or a financial page SMN3. Such pages (or columns) SMN include a political page, a general page, an international page, a sports page, a TV or radio program page, an editorial page, and a correspondence page.

In each page SMN, images such as a headline, a crosshead, a subhead, a text, and a picture or an illustration for each article KJD, i.e., for Article 1, Article 2, Article 3, . . . . In addition, audio can be added to them.

Furthermore, though there is a case in which one article KJD, one page SMN, or one newspaper information SBS is stored in one database or file, they are not necessarily stored in one storage medium. For example, only addresses to be linked for images may be stored in one file, and contents of the images are stored in the other storage medium assigned by the address. The same manner is applicable to other elements.

The newspaper information SBS is produced in conformity with a morning paper and an evening paper of the day when the newspaper is published. The newspaper information SBS stored in the publisher database DB41 is transmitted to the newspaper information host system 3 in a predetermined time zone in the morning and the evening.

Furthermore, although not being shown, if each publisher published a bulletin, bulletin information SHS that contains data of the bulletin is stored in the publisher database DB41 and is transmitted to the newspaper information host system 3 without a delay.

As shown in FIG. 3, the newspaper database DB34 of each publisher stores newspaper information SBK thereof. The newspaper information SBK comprises newspaper information SBS that is transmitted from the publisher and a keyword KW for each article KJD.

The newspaper information SBS is the same as that transmitted from each publisher system 4. The keyword KW is generated by the keyword forming portion 43 corresponding to contents of each article KJD.

Various methods can be used for generating the keyword KW. For example, the keyword KW can be selected from words that are used in the headline or the text of the article KJD. Alternatively, it can be selected from keywords KW that are registered beforehand.

As shown in FIG. 4, the bulletin database DB35 stores the bulletin information SHS that is transmitted from each publisher as it stands. The stored bulletin information SHS is soon transmitted to a contracted user in accordance with the contract contents memorized in the individual contract data memory portion 37.

As shown in FIG. 5, the individual contract data D371 include a membership number KIB, a contractor code KYC, a password PWD, a newspaper contract code SKC for each newspaper, a clipping contract code CKC, a delivery upper limit setting HJS, and a bulletin reception necessity SUY.

The membership number KIB is a number that is uniquely assigned to a member who can receive a predetermined service including a newspaper subscription provided by the electronic newspaper system 1. The contractor code KYC is a code that is uniquely assigned to a member who applied for the newspaper subscription provided by the electronic newspaper system 1. The password PWD is assigned to a member who was given the contractor code KYC, if required.

A-newspaper contract code and B-newspaper contract code SKC are codes indicating that the subscriptions of A-newspaper and B-newspaper are applied, respectively. The clipping contract code CKC is a code indicating that a service of delivering an article searched by a keyword KW is applied. When a subscription of each newspaper or a delivery of an article searched by a keyword KW is applied, a code showing the newspaper is set to be “1” or the name of the contracted newspaper or information indicating the clipping contract is registered.

The delivery upper limit setting HJS is used for setting an upper limit value of the data quantity when the newspaper information SBK is transmitted to the user terminal 6. Data exceeding the set upper limit value are not transmitted. The bulletin reception necessity SUY is a code indicating that the subscription of the bulletin information SHS is applied.

As shown in FIG. 6, the individual contract data D372 are used for setting the detail contents of the newspaper contract code SKC that is set in the individual contract data D371 shown in FIG. 5. The individual contract data D372 include the contractor code KYC, the newspaper contract code SKC, and a page contract code TSM.

The page contract code TSM is information indicating which page is desired for the newspaper information SBK of the publisher. Namely, the user can make a contract by designating a page such as a front page, a social page, or a financial page instead of designating all of the newspaper information SBK. The user designates a desired page. The designated page is registered as the page contract code TSM.

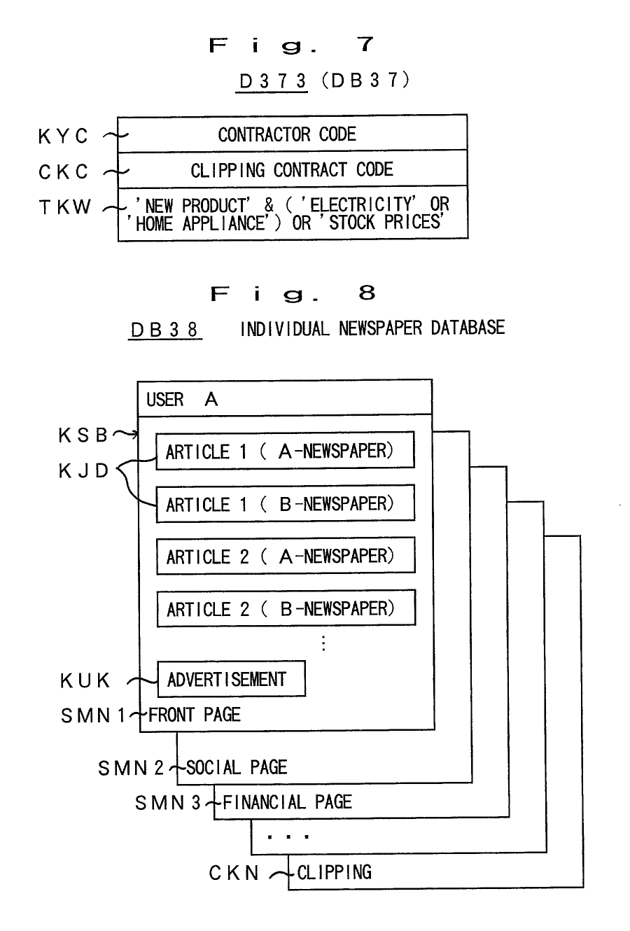

As shown in FIG. 7, the individual contract data D373 are used for setting the detail contents of the clipping contract code CKC when the clipping contract code CKC has been set in the individual contract data D371 shown in FIG. 5. The individual contract data D373 include the contractor code KYC, the clipping contract code CKC, and the keyword TKW.

As the keywords TKW, a plurality of words the user desires can be registered along with logic for applying the words. In the example shown in FIG. 7, words “new product”, “electricity”, “home appliance”, and “stock prices” are selected, and the headline and the text of each article KJD are searched with a logic of “new product” and (“electricity” or “home appliance”), or “stock prices”. The hit article KJD is extracted.

As shown in FIG. 8, the individual newspaper information KSB stored in the individual newspaper database DB38 is produced by editing the newspaper information that was searched and extracted by the current day edition processing portion 41 from the newspaper database DB34 for each user in accordance with the individual contract data D371-D373.

With the individual newspaper information KSB, each time the information is edited every morning and every evening, new individual newspaper information KSB is written and old individual newspaper information KSB is erased. Namely, only one piece of the individual newspaper information KSB is written in each individual newspaper database DB38. Therefore, the capacity of the individual newspaper database DB38 can be reduced.

In other words, the individual newspaper information KSB includes articles KJD for each contracted publisher of the contracted page SMN and the clipping page CKN for each user.

In each page SMN, an article KJD of the contracted publisher is placed for each relating article. Namely, with articles KJD included in one page SMN, headlines or the like are analyzed and compared so as to detect a relationship among the articles KJD, and relevant articles carried in each newspaper are allocated together.

In the example shown in FIG. 8, the article 1 of the A-publisher and the article 1 of the B-publisher are considered to be relevant to each other and allocated sequentially. In addition, the article 2 of the A-publisher and the article 2 of the B-publisher are considered to be relevant to each other and allocated sequentially.

Concerning the clipping page CKN too, in the same way as the page SMN, articles KJD of the contracted publisher are allocated for each article.

In addition, in each page SMN and the clipping page CKN, advertisement data KUK that are different for each page are allocated. The advertisement data KUK are allocated in the individual newspaper information KSB of a user, thereby the electronic publisher collects a fee for inserting advertisement from advertising agencies.

The newspaper picture HG1 shown in FIG. 9 is displayed in accordance with the newspaper file DB61 and the bulletin file DB62 stored in the user terminal 6.

Namely, the newspaper file DB61 stores the individual newspaper information KSB transmitted from the newspaper information host system 3 to the user terminal 6. The bulletin file DB62 stores the bulletin information SHS that is transmitted from the newspaper information host system 3 if the subscription of the bulletin information SHS has been applied. The individual newspaper information KSB and the bulletin information SHS are displayed as the newspaper picture HG1.

As shown in FIG. 9, the newspaper picture HG1 is displayed with each page SMN to which a tag is added, and each tag is clicked for displaying the article KJD of each page SMN. Each article KJD is allocated on the screen in the order of a headline, a crosshead, a subhead and a text. The article KJD is displayed after being allocated in the order of the individual newspaper information KSB shown in FIG. 8.

Images are displayed when an image mark displayed thereon is clicked. However, a thumbnail image can be displayed. In each page SMN, all of the necessary article KJD can be displayed by scrolling the screen. If the newspaper information SBS includes sound data, the sound goes out of a speaker (not shown).

In addition, in accordance with the advertisement data KUK, an advertisement KUK1 is displayed in a predetermined position in the newspaper picture HG1. The advertisement KUK1 is different for each page SMN. The advertisement KUK1 does not move when the screen is scrolled.

If bulletin information SHS is received when any page SMN is displayed, the bulletin window HG2 shown in FIG. 10 is displayed in the middle of the screen. Thus, the user can easily know that the bulletin information SHS is received. When an OK button of the bulletin window HG2 is clicked, a bulletin page is displayed on which the bulletin information SHS is displayed.

Furthermore, the bulletin window HG2 is also displayed when another optional screen is displayed and when the user terminal 6 is started, if a bulletin information SHS is received. In addition, the user can see the bulletin information SHS by clicking the bulletin tag as shown in FIG. 9.

In this way, the user can read the newspaper information SBS and the bulletin information SHS on the screen of the user terminal 6. In addition, the newspaper information SBS to be displayed is about the page SMN, the publisher, or the keyword KW that are selected by the user, so that unnecessary information is omitted, and only the information necessary for the user is displayed.

Therefore, unlike the conventional system, it eliminates the need to select necessary information, and the user can get necessary information in a short time. Moreover, the data quantity of the individual newspaper information KSB that is transmitted from the newspaper information host system 3 can be reduced, so that the transmission quantiy of data and data capacity of the newspaper file DB61 in the user terminal 6 can be reduced.

The user can also read the individual newspaper information KSB in the place where a user terminal 6 is not provided, by using a cellular phone or mobile equipment. In this case, it is possible to display only headlines on the mobile equipment and to transmit texts corresponding to headlines that the user designated on the screen to a facsimile of a designated number.

As shown in FIG. 11, it is possible to display the newspaper subscription order picture HG3 on the screen of the display device 62, and to input the individual contract data D371-D373 on the screen.

As shown in FIG. 11, fields for the membership number KIB and the name NME are displayed in the newspaper subscription order picture HG3, and the user inputs them. In the fields for the publisher and the page, the user inputs the desired newspaper and page SMN sequentially, and clicks an adding button BT11. Thus, the input contents become valid in the field of the contract state. An unnecessary newspaper or page can be erased from the field of the contract state by inputting them in the field of the publisher and the page and by clicking an erasing button BT12. The contents displayed in the field of the contract state indicate a newspaper and a page of desired subscription and are registered as the newspaper contract code SKC and the page contract code TSM.

The clipping contract is made by inputting a desired keyword in the field for the keyword KW and by clicking the adding button BT13. In addition, a necessary logical code is inputted. Thus, the inputted contents are reflected in the field of the contract state. The contents displayed in the field of the contract state are registered as the keyword TKW.

When desiring bulletin subscription, the user may input “desire” in the field for the bulletin subscription. When desiring reception of the individual newspaper information KSB at a place except home, the user may input “Yes” in the field for reception at a place except home. In this case, an appropriate password is inputted in the field of the password for setting.

Furthermore, the contractor code KYC is assigned to the user by the newspaper information host system 3 after the user applied for the newspaper subscription.

Though being not shown, the contract of the newspaper subscription can be made for a day unit, and cancellation or change of the contract can be made for a day unit, too. The contract only for a morning or evening paper is possible. The contract for a text file without images is possible depending upon a contract condition. The contract with time designation is possible, in which the newspaper information host system 3 generates the individual newspaper information KSB at the designated time and transmits it to the user terminal 6 of the user.

Thus, the user can easily apply for the newspaper subscription or change the contents of the contract on the newspaper subscription order picture HG3 displaced on the user terminal 6.

However, instead of the newspaper subscription order picture HG3, names of the publishers, pages of the publishers may be displayed as a list, so that a desired publisher and a desired page are checked off.

Furthermore, the application and change for the newspaper subscription can be performed by sending a filled-in paper by mail or facsimile instead of using the display screen of the user terminal 6.

In addition, the user can operate the user terminal 6 for inputting the field (page) for correspondence to each publisher, a scoop photograph, an article, which are transmitted to the newspaper information host system 3. After receiving them, the newspaper information host system 3 distributes them to each publisher if required. Thus, the publisher can receive contributions from users or analyze user's complaints or desires.

A user can request the past newspaper information SBK. In this case, the user may input necessary items using the user terminal 6 and transmits them to the newspaper information host system 3. In the newspaper information host system 3, the past edition processing portion 42 searches the newspaper information SBK from the newspaper database DB34 in accordance with the transmitted contents and extracts necessary information to be transmitted to the user terminal 6.

The newspaper subscription fee for the user is charged directly to the user's predetermined account in accordance with the contract. The newspaper subscription fee can be also charged directly using on-line banking.

FIG. 12 is a diagram showing a form of the recording medium ST storing the program for realizing the electronic newspaper system 1.

Such a program is installed in one or more of the newspaper information host system 3, the publisher system 4, and the user terminal 6. FIG. 12 shows a processor PS that is a target of the installation.

As shown in FIG. 12, it is possible to use a main memory provided in the processor PS, a memory device STA such as a RAM, a ROM, or a hard disk, a portable medium STB such as a CD-ROM, a floppy disk or a magneto-optical disk, a network medium STC such as a server or a DASD connected with a network or a communication line STD as the recording medium ST.

If the recording medium ST is the portable medium STB, the program is read out by a drive device corresponding to the types of the portable medium STB and is stored in the memory device STA of the processor PS or is loaded on the main memory for execution. If the recording medium ST is the network medium STC, the program is downloaded to the memory device STA via the communication line STD or is appropriately transferred for execution. The program can be supplied so as to work on various operating systems and platforms or under various system conditions or network conditions.

In the above-mentioned embodiment, various communication protocols can be used for the communication between the newspaper information host system 3 and the user terminal 6 or the publisher system 4. A personal computer, a work station, a general-purpose computer or other various computers or devices can be used as the newspaper information host system 3, the publisher system 4, the advertising agency's system 5 and the user terminal 6. The structure and the number of the entire or a part of the electronic newspaper system 1, the contents or the arrangement order of the database or the data, the contents, the order or the timing of the process, and the contents of the picture HG can be changed within the scope of the present invention.

The present invention can be applied to other various types of information delivery services without being limited to the newspaper information delivery.

According to the above-mentioned embodiment, the user can receive only the necessary information, which can be easily read. In addition, a quantity of data transmission and a storage capacity can be reduced. Furthermore, newspaper information desired by a user can be extracted correctly.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. An electronic information delivery system for delivering electronic information to a plurality of users, comprising:
an information database for storing the electronic information to be acquired;
a selection information storing portion for storing selection information for each user, the information being used for selecting necessary information from the electronic information;
an editing portion for searching and editing information necessary for each user using the selection information from the information stored in the information database;
a user-edited information storing portion for storing the edited information for each user; and
a transmitting portion for transmitting the information stored in the user-edited information storing portion to each user via a network.

2. The electronic information delivery system according to claim 1, wherein means for assigning a keyword to the electronic information to be stored in the information database are provided, the selection information includes a keyword selected by the user, and the editing portion searches and edits necessary information from the information stored in the information database in accordance with the keyword included in the selection information.

3. An electronic information delivery system for delivering newspaper information that is published by a plurality of publishers to a plurality of users, comprising:
a newspaper database for storing published newspaper information;
a selection information storing portion for storing selection information for each user, the information being used for selecting necessary newspaper information from the newspaper information;
an editing portion for searching and editing newspaper information necessary for each user using the selection information from the newspaper information stored in the newspaper database;
a user-edited information storing portion for storing the edited newspaper information for each user; and
a transmitting portion for transmitting the newspaper information stored in the user-edited information storing portion to each user via a network.

4. The electronic information delivery system according to claim 3, wherein the selection information includes publisher information that is used for selecting a publisher and page information that is used for selecting a newspaper page, and the editing portion is structured to edit necessary newspaper information for each of the page information.

5. The electronic information delivery system according to claim 4, wherein means for assigning a keyword to the newspaper information to be stored in the newspaper database are provided, the selection information includes a keyword selected by the user, and the editing portion searches necessary newspaper information from the newspaper information stored in the newspaper database in accordance with the keyword included in the selection information and edits the searched newspaper information as clipping information that is different from each page information that was edited for each of the page information.

6. The electronic information delivery system according to claim 3, wherein a bulletin database for storing bulletin information that is published by the publisher, the newspaper information is transmitted to a user twice at predetermined times in the morning and in the evening of the current day, and newly-published bulletin information is transmitted to a user without delay.

7. An electronic information delivery system for delivering newspaper information that is published by a plurality of publishers to a plurality of users, comprising:
a newspaper information host system; including
a newspaper database for storing published newspaper information,
a selection information storing portion for storing selection information for each user, the information being used for selecting necessary newspaper information from the newspaper information,
an editing portion for searching and editing newspaper information necessary for each user from the newspaper information stored in the newspaper database using the selection information,
a user-edited information storing portion for storing the edited newspaper information for each user, and
a transmitting portion for transmitting the newspaper information stored in the user-edited information storing portion to each user terminal via a network; and
a plurality of user terminals provided in each user being connected with the newspaper information host system via the network, each of the user terminals including
a memory device for storing newspaper information received from the newspaper information host system, and
a display device for displaying the newspaper information stored in the memory device.

8. The electronic information delivery system according to claim 7, wherein the display device of the user terminal displays the newspaper information for each page, and the display device displays a message indicating that a new bulletin information is received.

9. A computer program that is executed by a computer so as to realize an electronic information delivery system for delivering newspaper information that is published by a publisher to a plurality of users, process of the program comprising the steps of:
storing the published newspaper information in a newspaper database;
storing selection information that is used for selecting necessary newspaper information from the newspaper information in a selection information storing portion for each user;
searching and editing newspaper information necessary for each user from the newspaper information stored in the newspaper database using the selection information;
storing the edited newspaper information in a user-edited information storing portion for each user; and
transmitting the newspaper information stored in the user-edited information storing portion to each user via a network.

10. A computer-readable medium storing the computer program according to claim 9.
